(19) United States
(12) Patent Application Publication
(10) Pub. No.: US 2011/0184566 A1
(43) Pub. Date: Jul. 28, 2011

(54) CONTROL DEVICE, DATA STORAGE MEDIUM HAVING DATA STORED THEREON, SIGNAL SEQUENCE REPRESENTING DATA, AND METHOD FOR CONTROLLING A VENTILATION OPENING

(76) Inventors: Simone Steiger, Potzmes (DE); Runa T. Hellwig, Wamgau (DE); Andreas Holm, Gmund (DE)

(21) Appl. No.: 12/945,961

(22) Filed: Nov. 15, 2010

(30) Foreign Application Priority Data
Jan. 22, 2010 (DE) 20 2010 001 277.5

(51) Int. Cl. G05D 23/00

(52) U.S. Cl. 700/278

(57) ABSTRACT

The invention relates to a method for controlling a ventilation opening of a room comprising the following steps: receiving at least two input variables, fuzzifying said input variables, making a decision about an opening angle of a ventilation opening based on said fuzzified input variables, defuzzifying the decision about the opening angle and providing at least one actuating variable, and delivering said actuating variable to an actuating device, thereby controlling the opening angle of the ventilation opening wherein the input variables represent at least the CO₂ content of the air of a room and the inside temperature of said room, and wherein the output variable represents the opening angle of at least one ventilation opening, and the actuating variable being able to be supplied to at least one actuator which moves the ventilation opening. A control device and a storage medium having data stored thereon and a signal sequence which is suitable for transmission via a computer network and represents data, the data representing a program for execution on a microprocessor as part of a control device are also disclosed.

This application claims the benefit of and priority to DE utility model application 20 2010 001 277.5 filed Jan. 22, 2010.

### BACKGROUND OF THE INVENTION

1. Field of the Invention

The invention relates to a method and a control device comprising at least one fuzzifier which is adapted to receive at least two input variables, to fuzzify said input variables and to supply them to at least one decision-making unit which is adapted to receive the fuzzified input variables and provide at the output at least one output variable, the control device comprising further at least one defuzzifier which is adapted to receive the at least one output variable from the decision-making unit and to provide at least one actuating variable.

2. Description of Related Art

A control device of the generic type is known from L. Marjanovic, M. Eftekhari: Design and Simulation of a fuzzy controller for naturally ventilated buildings, Building Serv. Eng. Res. Technol. 25, 1 (2004)33-53. This known control device controls a ventilation opening, with the result that the inside temperature of the ventilated room is kept in a predefinable range. Therefore, in the case of cold outside temperatures, the ventilation opening remains closed in order to avoid heat loss. The disadvantage of this control device is therefore that, in the case of a high degree of occupancy of the room, for example in the case of a classroom, a seminar room or a conference room, the ventilation remains closed in the case of low outside temperatures and the air quality decreases very sharply.

### BRIEF SUMMARY OF THE INVENTION

The present invention is limited only by the scope of the claims as ultimately allowed in this application, and in no way limited by the prior versions of the claims.

It is an object of the present invention to provide a control device which can be used to provide a sufficient air quality and, at the same time, a comfortable inside temperature even if the rooms in question are occupied by a large number of people.

It is an object of the present invention to provide a control device which can be used to provide a sufficient air quality and, at the same time, maintain a comfortable inside temperature even at low outside temperatures, i.e. a temperature below 15° C., below 10° C., below 5° C., below 0° C., or below −5° C.

According to the invention, a fuzzy controller may be used which receives at least one signal representing the air quality and at least one signal representing the room temperature as input signals. The control device according to the invention may provide at least one output signal which represents an opening angle of at least one ventilation opening. In some embodiments, the ventilation opening may include at least one window. In some embodiments, the windows which are present in the room per se can be controlled in this manner such that the target variables of air quality and room temperature are kept stable in predefinable ranges. According to some embodiments of the invention, an undesirable decrease in air quality, cooling of the rooms in the winter or overheating of the rooms in the summer may be prevented. In some embodiments, the control device according to the invention or the proposed computer program for controlling the window ventilation is suitable for keeping the target variables of air quality and room temperature stable at the same time, even though these variables behave in an opposite manner in the winter.

In some embodiments of the invention, the proposed control device may be at least partially in the form of a program for a data processing device. Such a program can be executed on a microprocessor, a microcontroller or a known personal computer.

In some embodiments of the invention, the fuzzifier of the control device may be adapted to receive at least one further input variable, to fuzzify it and to supply it to the decision-making unit, the further input variables being selected from the outside temperature and/or wind speed and/or wind direction.

In some embodiments of the invention, the decision-making unit of the control device may be adapted to provide, at its output, at least one further output variable which indicates the heating power supplied to the room.

In some embodiments of the invention, the fuzzifier may be adapted to fuzzify an analogue input variable, which represents the CO₂ content of the room air, into 3 output values and/or to fuzzify an analogue input variable, which represents the inside temperature, into 3 or 4 output values and/or to fuzzify an analogue input variable, which represents the outside temperature, into 6 output values and/or to fuzzify an analogue input variable, which represents the wind direction, into 2 output values.

In some embodiments of the invention, the decision-making unit may be adapted to specify the output variable, which represents the opening angle of at least one window, in 5 output values and/or to specify the output variable, which indicates the heating power supplied to the room, in 5 output values.

In some embodiments of the invention, the control device may be adapted to keep the window closed in the case of a very cold outside temperature and a cold inside temperature.

In some embodiments of the invention, the control device may be adapted to change the window to a ventilation position with minimum air exchange in the case of a very cold outside temperature and a warm or pleasant inside temperature.

In some embodiments of the invention, the control device may be adapted to change the window to a ventilation position with maximum air exchange in the case of a very cold outside temperature and a high CO₂ content of the inside air.

In some embodiments of the invention, the control device may be adapted to keep the window closed in the case of a cold outside temperature, a cold inside temperature and a low or acceptable CO₂ content.

In some embodiments of the invention, the control device may be adapted to change the window to a ventilation position with minimum air exchange in the case of a cold outside temperature, a cold inside temperature and a high CO₂ content.

In some embodiments of the invention, the control device may be adapted to change the window to a ventilation position with minimum air exchange in the case of a cold outside temperature, a cold inside temperature and a high CO₂ content.

In some embodiments of the invention, the control device may be adapted to change the window to a ventilation position with minimum air exchange in the case of a cold outside temperature, a pleasant or warm inside temperature and a low or acceptable CO₂ content.

In some embodiments of the invention, the control device may be adapted to change the window to a ventilation position with little air exchange in the case of a cold outside temperature, a pleasant or warm inside temperature and a high CO₂ content.

In some embodiments of the invention, the control device may be adapted to change the window to a ventilation position with little air exchange in the case of a slightly cold outside temperature, a cold inside temperature and a high CO₂ content.

In some embodiments of the invention, the control device may be adapted to change the window to a ventilation position with high air exchange in the case of a slightly cold outside temperature, a pleasant or warm inside temperature and a high CO₂ content.

In some embodiments of the invention, the control device may be adapted to change the window to a ventilation position with high air exchange in the case of a mild outside temperature and a high CO₂ content.

In some embodiments of the invention, the control device may be adapted to change the window to a ventilation position with maximum air exchange in the case of a slightly warm outside temperature and a cold inside temperature.

In some embodiments of the invention, the control device may be adapted to keep the window closed in the case of a high wind speed.

### BRIEF DESCRIPTION OF THE DRAWINGS

FIG. 1 illustrates a block diagram of an embodiment of the control device according to an embodiment of the invention,

FIG. 2 illustrates different window arrangements which may be used in conjunction with the control device,

FIG. 3 illustrates the fuzzifying of the CO₂ content of the room air into three measurement ranges according to an embodiment of the invention,

FIG. 4 illustrates the fuzzifying of the inside temperature into three measurement ranges according to an embodiment of the invention,

FIG. 5 illustrates the fuzzifying of the outside temperature into six measurement ranges according to an embodiment of the invention,

FIG. 6 illustrates the fuzzifying of the wind speed into two measurement ranges according to an embodiment of the invention,

FIG. 7 illustrates the fuzzifying of the opening angle of a pivoting window into five ranges according to an embodiment of the invention,

FIG. 8 illustrates the fuzzifying of the opening angle of three bottom-hung windows into five ranges according to an embodiment of the invention,

FIG. 9 illustrates the fuzzifying of the heating power of a room heater into five ranges according to an embodiment of the invention,

FIG. 10 illustrates measurement results obtained using the proposed control device according to an embodiment of the invention.

### DETAILED DESCRIPTION OF THE INVENTION

The following is a detailed exemplary description of embodiments of the invention, in a number of its various aspects. Those skilled in the art will understand that the specificity provided herein is intended for illustrative purposes with respect to an exemplary embodiment, only, and is not to be interpreted as limiting the scope of the invention or claims.

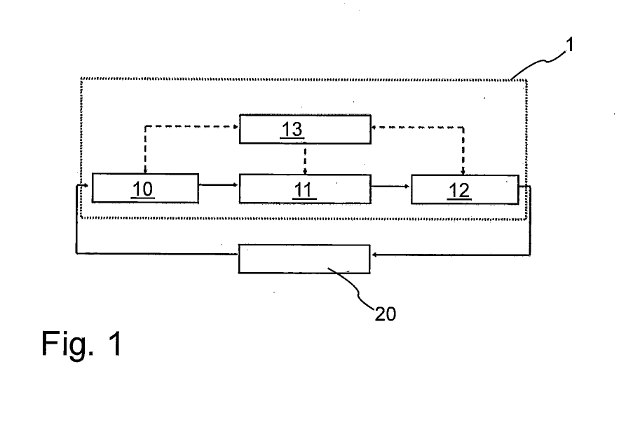

FIG. 1 illustrates a block diagram of a proposed control device 1. The control device 1 is adapted to control the air quality and the inside temperature inside a room 20 by means of free ventilation via the existing windows. For this purpose, measured values from associated sensors are supplied to a fuzzifier 10. The measured values include, in some embodiments, the inside temperature, the outside temperature, the CO₂ content as a measure of the air quality, the wind speed, the wind direction, the solar radiation or other values not explicitly mentioned here.

The fuzzifier 10 converts the recorded analogue or digital measured values into discrete values. The number of discrete values may fluctuate between 2 and approximately 10.

The values discretized in the fuzzifier 10 are then supplied to a decision-making unit 11. The decision-making unit 11 applies a plurality of decision rules to the recorded measured values in order to generate, a desired value for the window opening and/or the heating power supplied to the room and/or the power control for an air-conditioning system and/or other heating, cooling or ventilation devices. The rules applied by the decision-making unit 11 may be stored in a database 13. The rules stored in the database 13 may be individualized for a particular application, that is to say a particular room 20. However, in some embodiments, the set of rules may be applied so universally that it can be used for a plurality of rooms 20 in the same climate zone.

The desired values output by the decision-making unit 11 for the window opening, the heating control or other air-conditioning and/or ventilation devices are supplied to a defuzzifier 12. The defuzzifier 12 converts the value output by the decision-making unit 11 into an analogue or digital control signal which is then supplied to an actuator which controls the window opening, the ventilation setting or the heating control in order to influence the air quality and/or the temperature inside the room 20.

The room 20 may be, for example, a classroom, a seminar room or a conference room. The control device 1 therefore may take into account the fact that there may be a large number of people inside the room 20 who give rise to a high thermal load and a large air consumption. The control device 1 also may take into account in come embodiments the fact that people might be located adjacent to the outer walls of the room 20 and therefore adjacent to the window openings used for ventilation. The proposed control system therefore may be adapted to avoid a draught in this region.

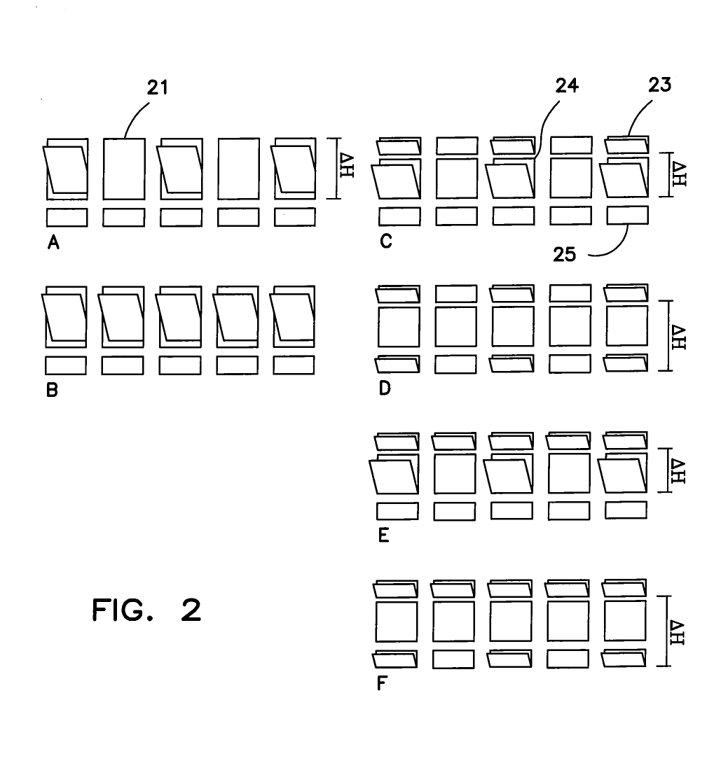

FIG. 2 illustrates six examples of the façade design of the room 20. The façade a and b illustrated in the left-hand part of the image comprises a plurality of window elements with pivoting wings. This produces a supply air opening on the lower edge of the window 22 and an exhaust air opening on the upper edge of the window by means of control using only one actuator. The two openings are separated by the height difference ΔH which influences the exchange of air. Depending on the desired air exchange, provision may be made for only one part of the windows to be provided with pivoting wings 22 and for another part of the windows to be in the form of fixed glazing 21. In other embodiments of the invention, all windows may be provided with pivoting wings. In this case, provision may be made for little air to be exchanged by opening a few windows and for additional windows to be opened in order to increase the air exchange.

The right-hand part of the image illustrates, in FIGS. 2c, 2d, 2e and 2f, a plurality of opening variants with tilting wings. The façade illustrated in FIGS. 2c to 2f has a row of upper bottom-hung windows 23, a row of middle bottom-hung windows 24 and a row of lower bottom-hung windows 25. It has proven to be favourable to always open two windows which are above one another, with the result that the lower window can be used as a supply air opening and the upper window can be used as an exhaust air opening. The supply air and exhaust air openings are then again offset with respect to one another by the distance ΔH.

In some embodiments of the invention, the upper windows 23 may be permanently open, whereas the air exchange is controlled by opening and closing the lower or middle windows. Other embodiments of the invention may provide for also closing the upper windows in order to save heating energy in the case of cold outside temperatures. In some embodiments of the invention, all windows illustrated may be opened in order to allow uniform air admission in this manner. In other embodiments of the invention, only one part of the windows can be opened and another part may be in the form of fixed glazing.

### First Exemplary Embodiment

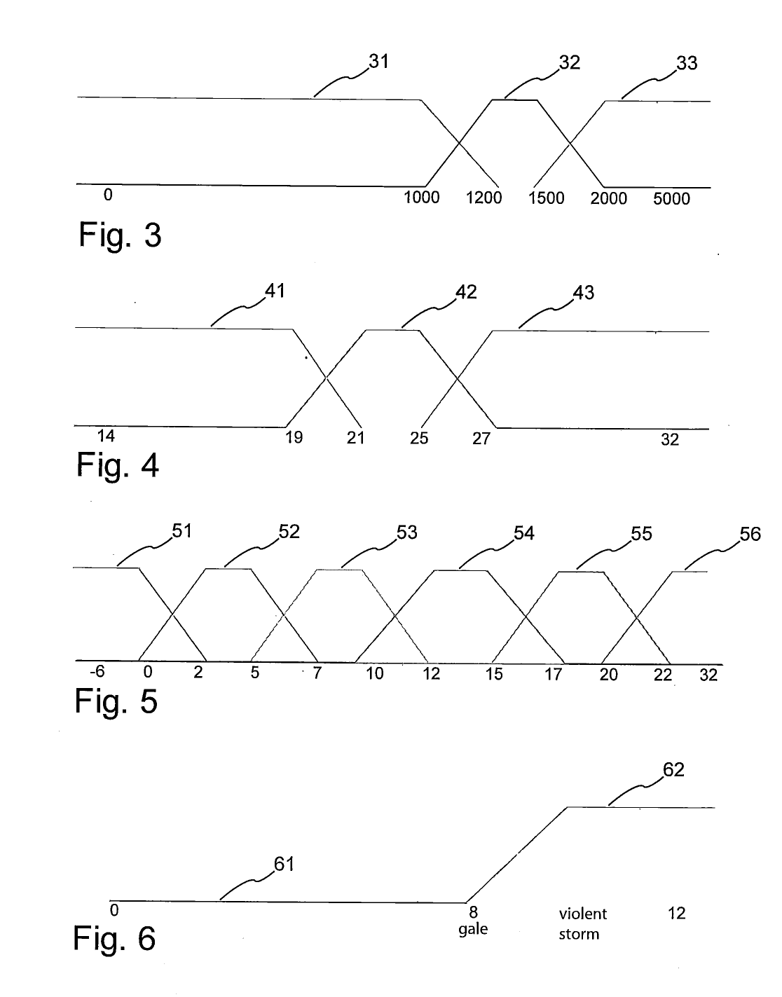

In a first exemplary embodiment, the air quality and the room temperature of a room 20 are intended to be kept within a predefinable desired range by automatically opening and closing a predefinable number of windows. For this purpose, the carbon dioxide content of the air inside the room 20 is used as a measure of the air quality. The measured value of the CO₂ concentration recorded by at least one sensor is subdivided into three ranges of values 31, 32 and 33 in the fuzzifier 10, as illustrated in FIG. 3. In this case, the first range 31, which is referred to as “low” below, is allocated to a measured value of less than 1000 ppm. The second range 32, which is referred to as “acceptable” below, is allocated to a measured value of between 1000 and 2000 ppm. Finally, a measured value above 2000 ppm leads to the third value 33 with the designation “high”.

The ranges may be weighted at the transition between the ranges 31 and 32 and at the transition between the ranges 32 and 33, such that said ranges each proportionally apply. For a measured value of 1100 ppm CO₂ for example, half of the first range 31 and half of the second range 32 can be respectively assumed.

FIG. 4 illustrates the fuzzification of the temperature measured inside the room 20. The inside temperature Ti is also subdivided into three ranges 41, 42 and 43 in the fuzzifier 10. In this case, the temperature of <19° C. is assigned to the first range 41. The verbal designation for the first range 41 is “cold” below. The second range 42 which extends in the temperature range from 21° to 25° C. is assigned the verbal designation “pleasant”. The third range 43 with the designation “warm” applies for inside temperatures above 27° C. The ranges may be weighted at the transition between the ranges 41 and 42 and at the transition between the ranges 42 and 43 respectively, such that said ranges each proportionally apply.

FIG. 5 illustrates the fuzzification of the outside temperature Ta in six ranges. According to FIG. 5, the designation “very cold” is assigned to the temperature range 51 below 0° C. The range 52 between 2° C. and 5° C. is referred to as “cold”. The next range 53 between 7° C. and 10° C. has the designation “slightly cold”. The range 54 with the designation “mild” applies between 10° C. and 15° C. An outside temperature in the range 55 between 17° C. and 20° C. is referred to as “slightly warm”. Finally, outside temperatures above 22° C. in the range 56 are considered to be “warm”. At the transitions between the ranges, the temperature ranges according to FIG. 4 and FIG. 5 can also be partially assumed, as already explained in connection with FIGS. 3 and 4.

FIG. 6 illustrates the fuzzification of the wind speed in two values. According to FIG. 6, the first value 61 with the designation “low” applies for wind speeds below 8 Beaufort. Wind speeds above 11 Beaufort are assigned to the range 62 with the designation “high”. The transition range in which the values “high” and “low” are partially assumed is between 8 and 11 Beaufort.

After the recorded measured values have been fuzzified according to FIG. 3 to FIG. 6, these measured values are supplied to the decision-making unit 11. The decision-making unit 11 makes a decision with respect to the opening angle of the windows which is to be applied in each case according to Table 1. The advantages of the invention include the fact that a small number of 15 to 50 rules, for example, suffices to automate the ventilation behaviour. This makes it possible to save heating energy and to simultaneously improve the air quality and the inside temperature. As a result of the low degree of complexity of the decision-making unit 11, the control device 1 can be easily adapted to changed climatic conditions, changed façade designs or changed degrees of occupancy of the room. An empty field in Table 1 denotes a rule which is not dependent on the measured value which has respectively not been cited.

TABLE 1

| V_{W} | Tₐ | Tᵢ | CO₂ | Ventilation |
|---|---|---|---|---|
| Low 61 | Very cold | Cold 41 | | Close 71 |
| | 51 | | | |
| Low 61 | Very cold | Pleasant | | Minimum 72 |
| | 51 | 42/warm | | |
| | | 43 | | |
| Low 61 | Very cold | | High 33 | Maximum 75 |
| | 51 | | | |
| Low 61 | Cold 52 | Cold 41 | Low 31 and | Close 71 |
| | | | acceptable | |
| | | | 32 | |
| Low 61 | Cold 52 | Cold 41 | High 33 | Minimum 72 |
| Low 61 | Cold 52 | Pleasant | Low 31 and | Minimum 72 |
| | | 42/warm | acceptable | |
| | | 43 | 32 | |
| Low 61 | Cold 52 | Pleasant | High 33 | Little 73 |
| | | 42/warm | | |
| | | 43 | | |
| Low 61 | Slightly | Cold 41 | Low 31 and | Minimum 72 |
| | cold 53 | | acceptable | |
| | | | 32 | |
| Low 61 | Slightly | Cold 41 | High 33 | Little 73 |
| | cold 53 | | | |
| Low 61 | Slightly | Pleasant | Low 31 and | Little 73 |
| | cold 53 | 42/warm | acceptable | |
| | | 43 | 32 | |
| Low 61 | Slightly | Pleasant | High 33 | A lot 74 |
| | cold 53 | 42/warm | | |
| | | 43 | | |
| Low 61 | Mild 54 | | Low 31 | Minimum 72 |
| Low 61 | Mild 54 | | Acceptable | Little 73 |
| | | | 32 | |
| Low 61 | Mild 54 | | High 33 | A lot 74 |
| Low 61 | Slightly | | Low 31 | Little 73 |
| | warm 55 | | | |
| Low 61 | Slightly | | Acceptable | A lot 74 |
| | warm 55 | | 32 | |
| Low 61 | Slightly | | High 33 | Maximum 75 |
| | warm 55 | | | |
| Low 61 | Slightly | Warm 43 | | Maximum 75 |
| | warm 55 | | | |
| Low 61 | Warm 56 | | | Maximum 75 |
| High 62 | | | | Close 71 |

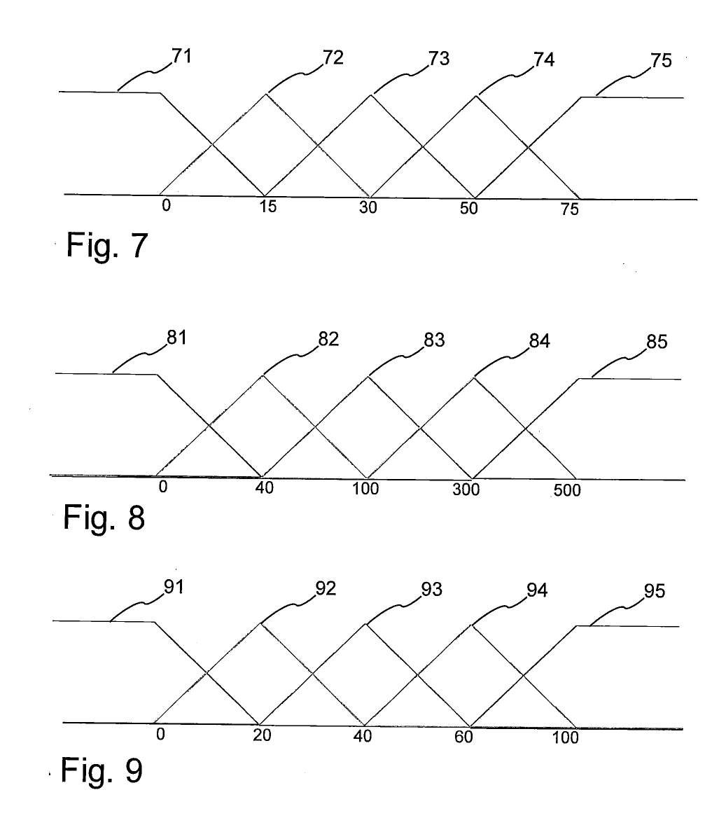

In the exemplary embodiment illustrated, the decision-making unit 11 outputs the opening angle of a pivoting window 22 in five discrete stages. The five discrete stages are converted into a specific opening angle in the defuzzifier 12, as illustrated in FIG. 7. The first range 71 with the designation “close” is therefore assigned to an opening angle which is 0% of the maximum opening angle. An opening angle of 15% of the maximum opening is described by the second range 72 and has the designation “minimum”. 30% of the maximum opening angle denotes the range 73 with the designation “little”. The ventilation position “high” is assigned to the fourth range 74 which corresponds to an opening angle of 50%. The range 75 describes “maximum” ventilation, that is to say an opening angle of 75% of the maximum value. Intermediate values can be calculated in the transition zones, as already described above for the input variables. Discrete opening angles can also be sometimes present in this manner, with the result that a continuous value for driving the actuators which move the windows can be provided at the output of the defuzzifier. In order to adapt the ventilation behaviour to different structural situations, the maximum opening angle can be adapted on the basis of the respective height difference ΔH, with the result that the decision rules stored in the decision-making unit 11 or the database 13 need not be adapted.

### Second Exemplary Embodiment

In a second exemplary embodiment, the same input values with the same ranges of values are supplied to the fuzzifier 10, as described above using FIG. 3 to FIG. 6.

If the room 20 is provided with pivoting windows according to FIG. 2a and FIG. 2b, these windows can be controlled according to FIG. 7 described above. If the room 20 has bottom-hung windows according to FIG. 2c, 2d, 2e or 2f, the opening angle can likewise be subdivided by the defuzzifier into five ranges of values 81 to 85 according to FIG. 8. In this case, the range 81 denotes a completely closed window. Minimum ventilation with an opening angle of 40% of the maximum opening angle is described by the range 82. The range 83 describes the ventilation range “little” with an opening angle of 100%. In the exemplary embodiment illustrated, shock ventilation can also be achieved by opening further windows in the ranges 84 and 85.

In the embodiment described here, the room heating is also included in the control device 1. The defuzzifier 12 therefore also provides a value for the heating power supplied to the room. According to FIG. 9, the heating power is determined in five values. In this case, the range 91 denotes the closed range, that is to say the heating power supplied to the room is 0% of the maximum heating power. In the second range 92, the room is heated “a little”, that is to say with 20% of the maximum heating power. In the “medium” range 93, the heating power is 40%. The range 94 denotes a large heating power at 60%. Finally, the maximum heating power of 100% is supplied in the range 95.

Table 2 shows the decisions made in the decision-making unit 11 according to the second exemplary embodiment with respect to the window opening and the heating power supplied to the room. In Table 2 as well, empty fields denote a rule which is independent of the respective input variable. For example, in the case of a high wind speed, the window is kept closed irrespective of the inside and outside temperatures and the air quality. This rule is therefore used as a caution rule in order to avoid damage to the building. It is clear from Table 2 that the control device 1 requires only a small amount of additional complexity in order to also control the heating power and thus to keep the room temperature inside a predefinable range in a particularly reliable manner and with reduced energy consumption.

TABLE 2

| V_{W} | Tₐ | Tᵢ | CO₂ | Heating | Ventilation |
|---|---|---|---|---|---|
| Low | Very | Cold 41 | Low 31 and | Max 95 | Close 71/81 |
| 61 | cold 51 | | acceptable | | |
| | | | 32 | | |
| Low | Very | Cold 41 | High 33 | Max 95 | Minimum |
| 61 | cold 51 | | | | 72/82 |
| Low | Very | Pleasant | Low 31 and | A lot | Minimum |
| 61 | cold 51 | 42 | acceptable | 94 | 72/82 |
| | | | 32 | | |
| Low | Very | Pleasant | High 33 | A lot | Little |
| 61 | cold 51 | 42 | | 94 | 73/83 |
| Low | Very | Warm 43 | Low 31 and | Medium | Minimum |
| 61 | cold 51 | | acceptable | 93 | 72/82 |
| | | | 32 | | |
| Low | Very | Warm 43 | High 33 | Medium | Little |
| 61 | cold 51 | | | 93 | 73/83 |
| Low | Cold 52 | Cold 41 | Low 31 and | A lot | Close 71/81 |
| 61 | | | acceptable | 94 | |
| | | | 32 | | |
| Low | Cold 52 | Cold 41 | High 33 | A lot | Minimum |
| 61 | | | | 94 | 72/82 |
| Low | Cold 52 | Pleasant | Low 31 and | Medium | Minimum |
| 61 | | 42 | acceptable | 93 | 72/82 |
| | | | 32 | | |
| Low | Cold 52 | Pleasant | High 33 | Medium | Little |
| 61 | | 42 | | 93 | 73/83 |
| Low | Cold 52 | Warm 43 | Low 31 and | Little | Minimum |
| 61 | | | acceptable | 92 | 72/82 |
| | | | 32 | | |
| Low | Cold 52 | Warm 43 | High 33 | Little | Little |
| 61 | | | | 92 | 73/83 |
| Low | Slightly | Cold 41 | Low 31 | Medium | Close 71/81 |
| 61 | cold 53 | | | 93 | |
| Low | Slightly | Cold 41 | Acceptable | Medium | Minimum |
| 61 | cold 53 | | 32 | 93 | 72/82 |
| Low | Slightly | Cold 41 | High 33 | A lot | Little |
| 61 | cold 53 | | | 94 | 73/83 |
| Low | Slightly | Pleasant | Low 31 | Little | Minimum |
| 61 | cold 53 | 42 | | 92 | 72/82 |
| Low | Slightly | Pleasant | Acceptable | Little | Little |
| 61 | cold 53 | 42 | 32 | 92 | 73/83 |
| Low | Slightly | Pleasant | High 33 | Medium | A lot 74/84 |
| 61 | cold 53 | 42 | | 93 | |
| Low | Slightly | Warm 43 | Low 31 | Close | Little |
| 61 | cold 53 | | | 91 | 73/83 |
| Low | Slightly | Warm 43 | Acceptable | Little | A lot 74/84 |
| 61 | cold 53 | | 32 | 92 | |
| Low | Slightly | Warm 43 | High 33 | Little | A lot 74/84 |
| 61 | cold 53 | | | 92 | |
| Low | Mild 54 | | Low 31 | Close | Little |
| 61 | | | | 91 | 73/83 |
| Low | Mild 54 | | Acceptable | Close | A lot 74/84 |
| 61 | | | 32 and | 91 | |
| | | | high 33 | | |
| Low | Slightly | | Low 31 | Close | A lot 74/84 |
| 61 | warm 55 | | | 91 | |
| Low | Slightly | | Acceptable | Close | Maximum |
| 61 | warm 55 | | 32 and | 91 | 75/85 |
| | | | high 33 | | |
| Low | Slightly | Warm 43 | | Close | Maximum |
| 61 | warm 55 | | | 91 | 75/85 |
| Low | Warm 56 | | | Close | Maximum |
| 61 | | | | 91 | 75/85 |
| High | | | | | Close 71/81 |
| 62 | | | | | |

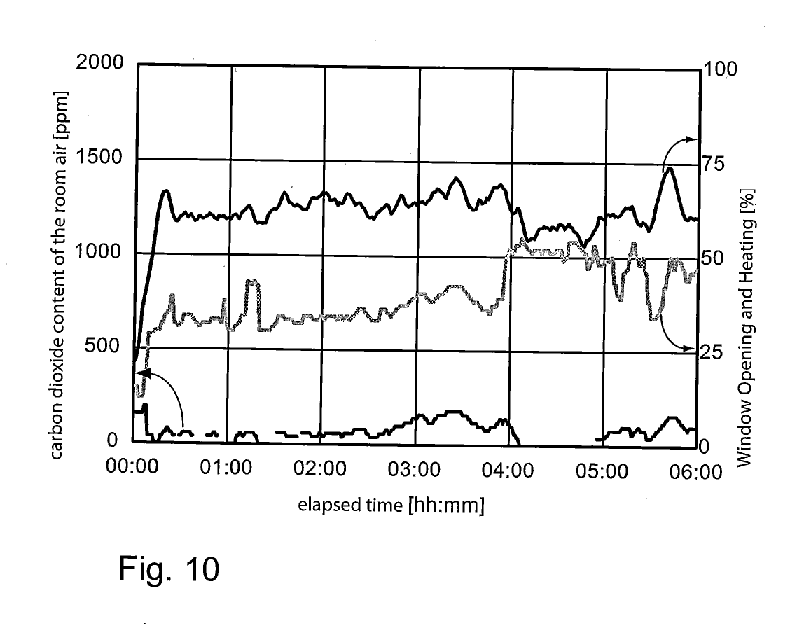

FIG. 10 illustrates measured values obtained using a control device according to FIG. 1. In this case, the test building comprises a room having space for 24 people. The people were replaced with people load simulators which emit heat and carbon dioxide. The outside temperatures were between 8° C. and 14° C. The room was provided with pivoting wings according to FIGS. 2a and 2b.

At the beginning of the test, FIG. 10 illustrates a carbon dioxide content of approximately 100 ppm. At the beginning of the test, the heating power is approximately 25% and the window opening is approximately 15%. After a few minutes, the windows are opened to approximately 30%, which makes it possible to reduce the carbon dioxide content of the room air to close to the measurement limit. At the same time, the heating power is increased to approximately 60% in order to compensate for the fall in room temperature. As the test proceeds, it is possible to always keep the carbon dioxide content below 2000 ppm. Therefore, despite the room being occupied by 24 people, the carbon dioxide content does not rise into an unacceptable range.

At the same time, the temperature is kept in a pleasant range by automatically controlling the windows and the heating power.

The invention has been described in the form of functional elements. Those elements are known to those skilled in the art and may be realized in different embodiments. The functional elements of the invention can be implemented using hardware or software. These elements can be combined with one another in different ways. In some embodiments, parts of the proposed control device may also be integrated, for example in a single component, a single subassembly or a program for a data processing device. The invention does not rely on the strict realization of a certain embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting. Therefore, it is intended that this invention be limited only by the claims and the equivalents thereof.

1. A Control device comprising
at least one fuzzifier having at least one input and at least one output, the fuzzifier being adapted to receive at least two input variables, to fuzzify said input variables and to supply them to the at least one output,
at least one decision-making unit having at least one input and at least one output, said input being coupled to the at least one output of the fuzzifier, the decision-making unit being adapted to receive the fuzzified input variables and to provide at least one output variable at the output, and
at least one defuzzifier having at least one input and at least one output, said input being coupled to the at least one output of the decision-making unit and said defuzzifier being adapted to receive the at least one output variable from the decision-making unit and to provide at least one actuating variable at the output,
wherein the input variables represent at least the CO₂ content of the air of a room and the inside temperature of said room, the output variable represents the opening angle of at least one ventilation opening, and the actuating variable can be supplied, as a drive signal, to at least one actuator which influences the ventilation opening.

2. The control device according to claim 1, wherein the fuzzifier is adapted to receive at least one further input variable, to fuzzify it and to supply it to the decision-making unit, the further input variables being selected from the outside temperature and/or outside wind speed and/or outside wind direction.

3. The control device according to claim 1, wherein the decision-making unit is adapted to provide, at its output, at least one further output variable which indicates the heating power supplied to the room.

4. The control device according to claim 2, wherein the fuzzifier is adapted to
fuzzify the analogue input variable, which represents the CO₂ content of the room air, into 3 output values and/or
to fuzzify the analogue input variable, which represents the inside temperature, into 3 or 4 output values and/or
to fuzzify the analogue input variable, which represents the outside temperature, into 6 output values and/or
to fuzzify the analogue input variable, which represents the wind speed, into 2 output values.

5. The control device according to claim 3, wherein the decision-making unit is adapted
to specify the output variable, which represents the opening angle of at least one ventilation opening, in 5 output values and/or
to specify the output variable, which indicates the heating power supplied to the room, in 5 output values.

6. The control device according to claim 2, wherein the control device is adapted to keep the ventilation opening closed in the case of a very cold outside temperature and a cold inside temperature.

7. The control device according to claim 2, wherein the control device is adapted to change the ventilation opening to a position with minimum air exchange in the case of a very cold outside temperature and a warm or pleasant inside temperature.

8. The control device according to claim 2, wherein the control device is adapted to change the ventilation opening to a position with maximum air exchange in the case of a very cold outside temperature and a high CO₂ content.

9. The control device according to claim 2, wherein the control device is adapted to keep the ventilation opening closed in the case of a cold outside temperature, a cold inside temperature and a low or acceptable CO₂ content.

10. The control device according to claim 2, wherein the control device is adapted to change the ventilation opening to a position with minimum air exchange in the case of a cold outside temperature, a cold inside temperature and a high CO₂ content.

11. The control device according to claim 2, wherein the control device is adapted to change the ventilation opening to a position with minimum air exchange in the case of a cold outside temperature, a cold inside temperature and a high CO₂ content.

12. The control device according to claim 2, wherein the control device is adapted to change the ventilation opening to a position with minimum air exchange in the case of a cold outside temperature, a pleasant or warm inside temperature and a low or acceptable CO₂ content.

13. The control device according to claim 2, wherein the control device is adapted to change the ventilation opening to a position with little air exchange in the case of a cold outside temperature, a pleasant or warm inside temperature and a high CO₂ content.

14. The control device according to claim 2, wherein the control device is adapted to change the ventilation opening to a position with little air exchange in the case of a slightly cold outside temperature, a cold inside temperature and a high CO₂ content.

15. The control device according to claim 2, wherein the control device is adapted to change the ventilation opening to a position with high air exchange in the case of a slightly cold outside temperature, a pleasant or warm inside temperature and a high CO₂ content.

16. The control device according to claim 2, wherein the control device is adapted to change the ventilation opening to a position with high air exchange in the case of a mild outside temperature and a high CO₂ content.

17. The control device according to claim 2, wherein the control device is adapted to change the ventilation opening to a position with maximum air exchange in the case of a slightly warm outside temperature and a cold inside temperature.

18. The control device according to claim 2, wherein the control device is adapted to keep the ventilation opening closed in the case of a high wind speed.

19. A data storage medium having data stored thereon or signal sequence which is suitable for transmission via a computer network and represents data, the data representing a program for execution on a microprocessor as part of a control device, the program being designed
to implement at least one fuzzifier which is adapted to receive at least two input variables, to fuzzify them and to supply them to a decision-making unit,
to implement at least one decision-making unit which is adapted to receive the fuzzified input variables and at the output of which at least one output variable can be provided, and
to implement at least one defuzzifier which is adapted to receive the output variable from the decision-making unit and at the output of which at least one actuating variable can be provided,
wherein the input variables represent at least the CO₂ content of the air of a room and the inside temperature of said room, and
wherein the output variable represents the opening angle of at least one ventilation opening, and the actuating variable being able to be supplied to at least one actuator which moves the ventilation opening.

20. The data storage medium having data stored thereon or signal sequence according to claim 19, wherein the fuzzifier is adapted to receive at least one further input variable, to fuzzify it and to supply it to the decision-making unit, the further input variables being selected from the outside temperature and/or wind speed and/or wind direction.

21. The data storage medium having data stored thereon or signal sequence according to claim 19, wherein the decision-making unit is adapted to provide, at its output, at least one further output variable which indicates the heating power supplied to the room.

22. The data storage medium having data stored thereon or signal sequence according to claim 20, wherein the fuzzifier is adapted
to fuzzify the analogue input variable, which represents the CO₂ content of the room air, into 3 output values and/or
to fuzzify the analogue input variable, which represents the inside temperature, into 3 or 4 output values and/or
to fuzzify the analogue input variable, which represents the outside temperature, into 6 output values and/or
to fuzzify the analogue input variable, which represents the wind speed, into 2 output values.

23. The data storage medium having data stored thereon or signal sequence according to claim 20, wherein the decision-making unit is adapted
to specify the output variable, which represents the opening angle of at least one ventilation opening, in 5 output values and/or
to specify the output variable, which indicates the heating power supplied to the room, in 5 output values.

24. The data storage medium having data stored thereon or signal sequence according to claim 20, wherein the decision-making unit is adapted to keep the ventilation opening closed in the case of a very cold outside temperature and a cold inside temperature.

25. The data storage medium having data stored thereon or signal sequence according to claim 20, wherein the decision-making unit is adapted to change the ventilation opening to a ventilation position with minimum air exchange in the case of a very cold outside temperature and a warm or pleasant inside temperature.

26. The data storage medium having data stored thereon or signal sequence according to claim 20, wherein the decision-making unit is adapted to change the ventilation opening to a ventilation position with maximum air exchange in the case of a very cold outside temperature and a high CO₂ content.

27. The data storage medium having data stored thereon or signal sequence according to claim 20, wherein the decision-making unit is adapted to keep the ventilation opening closed in the case of a cold outside temperature, a cold inside temperature and a low or acceptable CO₂ content.

28. The data storage medium having data stored thereon or signal sequence according to claim 20, wherein the decision-making unit is adapted to change the ventilation opening to a ventilation position with minimum air exchange in the case of a cold outside temperature, a cold inside temperature and a high CO₂ content.

29. The data storage medium having data stored thereon or signal sequence according to claim 20, wherein the decision-making unit is adapted to change the ventilation opening to a ventilation position with minimum air exchange in the case of a cold outside temperature, a cold inside temperature and a high CO₂ content.

30. The data storage medium having data stored thereon or signal sequence according to claim 20, wherein the decision-making unit is adapted to change the ventilation opening to a ventilation position with minimum air exchange in the case of a cold outside temperature, a pleasant or warm inside temperature and a low or acceptable CO₂ content.

31. The data storage medium having data stored thereon or signal sequence according to claim 20, wherein the decision-making unit is adapted to change the ventilation opening to a ventilation position with little air exchange in the case of a cold outside temperature, a pleasant or warm inside temperature and a high CO₂ content.

32. The data storage medium having data stored thereon or signal sequence according to claim 20, wherein the decision-making unit is adapted to change the ventilation opening to a ventilation position with little air exchange in the case of a slightly cold outside temperature, a cold inside temperature and a high CO₂ content.

33. The data storage medium having data stored thereon or signal sequence according to claim 20, wherein the decision-making unit is adapted to change the ventilation opening to a ventilation position with high air exchange in the case of a slightly cold outside temperature, a pleasant or warm inside temperature and a high CO₂ content.

34. The data storage medium having data stored thereon or signal sequence according to claim 20, wherein the decision-making unit is adapted to change the ventilation opening to a ventilation position with high air exchange in the case of a mild outside temperature and a high CO₂ content.

35. The data storage medium having data stored thereon or signal sequence according to claim 20, wherein the decision-making unit is adapted to change the ventilation opening to a ventilation position with maximum air exchange in the case of a slightly warm outside temperature and a cold inside temperature.

36. The data storage medium having data stored thereon or signal sequence according to claim 20, wherein the decision-making unit is adapted to keep the ventilation opening closed in the case of a high wind speed.

37. A method for controlling a ventilation opening of a room comprising the following steps:
receiving at least two input variables,
fuzzifying said input variables
making a decision about an opening angle of a ventilation opening based on said fuzzified input variables,
defuzzifying the decision about the opening angle and providing at least one actuating variable, and
delivering said actuating variable to an actuating device, thereby controlling the opening angle of the ventilation opening
wherein the input variables represent at least the CO₂ content of the air of a room and the inside temperature of said room, and
wherein the output variable represents the opening angle of at least one ventilation opening, and the actuating variable being able to be supplied to at least one actuator which moves the ventilation opening.

38. The method according to claim 37, wherein at least one further input variable is received and fuzzified and the decision is based on this at least one further input variable, the further input variables being selected from the outside temperature and/or wind speed and/or wind direction.

39. The method according to 37, wherein a further decision is made which indicates the heating power supplied to the room.

40. The method according to 38, wherein
an analogue input variable, which represents the CO₂ content of the room air, is fuzzified into 3 output values and/or
an analogue input variable, which represents the inside temperature, is fuzzified into 3 or 4 output values and/or
an analogue input variable, which represents the outside temperature, is fuzzified into 6 output values and/or
an analogue input variable, which represents the wind speed, is fuzzified into 2 output values.

41. The method according to 38, wherein the ventilation opening is kept closed in the case of a very cold outside temperature and a cold inside temperature.

42. The method according to 38, wherein the ventilation opening is brought to a ventilation position with minimum air exchange in the case of a very cold outside temperature and a warm or pleasant inside temperature.

43. The method according to 38, wherein is brought the ventilation opening is brought to a ventilation position with maximum air exchange in the case of a very cold outside temperature and a high CO₂ content.

44. The method according to 38, wherein the ventilation opening is kept closed in the case of a cold outside temperature, a cold inside temperature and a low or acceptable CO₂ content.

45. The method according to 38, wherein the ventilation opening is brought to a ventilation position with minimum air exchange in the case of a cold outside temperature, a cold inside temperature and a high CO₂ content.

46. The method according to 38, wherein the ventilation opening is brought to a ventilation position with minimum air exchange in the case of a cold outside temperature, a cold inside temperature and a high CO₂ content.

47. The method according to claim 38, wherein the ventilation opening is brought to a ventilation position with minimum air exchange in the case of a cold outside temperature, a pleasant or warm inside temperature and a low or acceptable CO₂ content.

48. The method according to claim 38, wherein the ventilation opening is brought to a ventilation position with little air exchange in the case of a cold outside temperature, a pleasant or warm inside temperature and a high CO₂ content.

49. The method according to claim 38, wherein the ventilation opening is brought to a ventilation position with little air exchange in the case of a slightly cold outside temperature, a cold inside temperature and a high CO₂ content.

51. The method according to claim 38, wherein the ventilation opening is brought to a ventilation position with high air exchange in the case of a slightly cold outside temperature, a pleasant or warm inside temperature and a high CO₂ content.

52. The method according to claim 38, wherein the ventilation opening is brought to a ventilation position with high air exchange in the case of a mild outside temperature and a high CO₂ content.

53. The method according to claim 38, wherein the ventilation opening is brought to a ventilation position with maximum air exchange in the case of a slightly warm outside temperature and a cold inside temperature.

54. The method according to claim 38, wherein the ventilation opening is closed in the case of a high wind speed.
